(19) United States
(12) Patent Application Publication
(10) Pub. No.: US 2014/0059918 A1
(43) Pub. Date: Mar. 6, 2014

(54) Mosquito Trap

(71) Applicant: Fen Lin, Taipei City (TW)

(72) Inventor: Fen Lin, Taipei City (TW)

(21) Appl. No.: 13/600,984

(22) Filed: Aug. 31, 2012

(51) Int. Cl. A01M 1/04; A01M 1/10

(52) U.S. Cl. 43/113

(57) ABSTRACT

A mosquito trap includes a case being transparent, a light cover mounted on a top end of the case, an inducing light located in the light cover, a fan capable of producing airflow toward the inside of the case mounted in the bottom of the case, and a collecting box located beneath the case, wherein the fan has multiple fan blades having black portions and white portions mounted therein, thereby producing twinkling as the fan starts to rotate, and thus the mosquitoes can be induced to get close to the mosquito trap of the present invention and improve the effect of catching mosquitoes.

### FIELD OF THE INVENTION

The present invention relates to a mosquito trap, especially to a mosquito trap using black fan blades and white fan blades to improve effects of catching mosquitoes.

### DESCRIPTION OF RELATED ART

Conventional mosquito trap 7 as shown in FIG. 4, includes a light source 71 which can induce mosquitoes to get close, a fan 72 which can produce airflow toward the inside of the mosquito trap 7 and a collecting box 73. When mosquitoes are induced to get close to the light source, then they will be entrained into the mosquito trap 7 by the airflow, falling down to the collecting box 73 and air-dried to die.

However, according to some researches, the nature of mosquitoes' preference is not only light source but carbon dioxide and moving objects. The conventional mosquito trap 7 only provides the light source 71 as one of the incentives to trapping mosquitoes. The effect of trapping mosquitoes will be improved if other incentives can be added to the mosquito trap 7.

Furthermore, the conventional mosquito trap 7 collects the trapped mosquitoes in the collecting box 73 and dries them. Nevertheless, the bodies of the trapped mosquitoes would become pollutants as located in the box for a long time, thereby producing bacteria and viruses that can be spread out through air and affect human's health. In another aspect, the bodies of the trapped mosquitoes in the box would emit bad smell (smell of hormones) that let mosquitoes get away from the trap with the smell, and reduce the effect of catching mosquitoes. Accordingly, the conventional mosquito trap requires improvement.

### SUMMARY OF THE INVENTION

The objective of present invention is to provide a mosquito trap, which includes black fan blades and white fan blades that produce twinkling to induce mosquitoes to get close the mosquito trap and then to be trapped.

To achieve the foregoing objective, a mosquito trap in according to the present invention is provided, which comprises a case being transparent, a light cover mounted on a top end of the case, an inducing light located in the light cover, a fan capable of producing airflow toward the inside of the case mounted in the bottom of the case, and a collecting box located beneath the case, characterized by:
multiple black fan blades and multiple white fan blades mounted in the fan, thereby producing twinkling as the fan starts to rotate.

Furthermore, when removing the collecting box located beneath the case, the mosquito trap of the present invention can be set on an aquarium operable of cultivating fish and make the trapped mosquitoes falling down to the aquarium as feed for the fish.

### BRIEF DESCRIPTION OF THE DRAWINGS

FIG. 1 is a perspective view of a first embodiment of a mosquito trap in accordance with the present invention;

FIG. 2 is a perspective view of a second embodiment of a mosquito trap in accordance with the present invention;

FIG. 3 is a perspective view of a third embodiment of a mosquito trap in accordance with the present invention; and

FIG. 4 is a schematic view of a conventional mosquito trap.

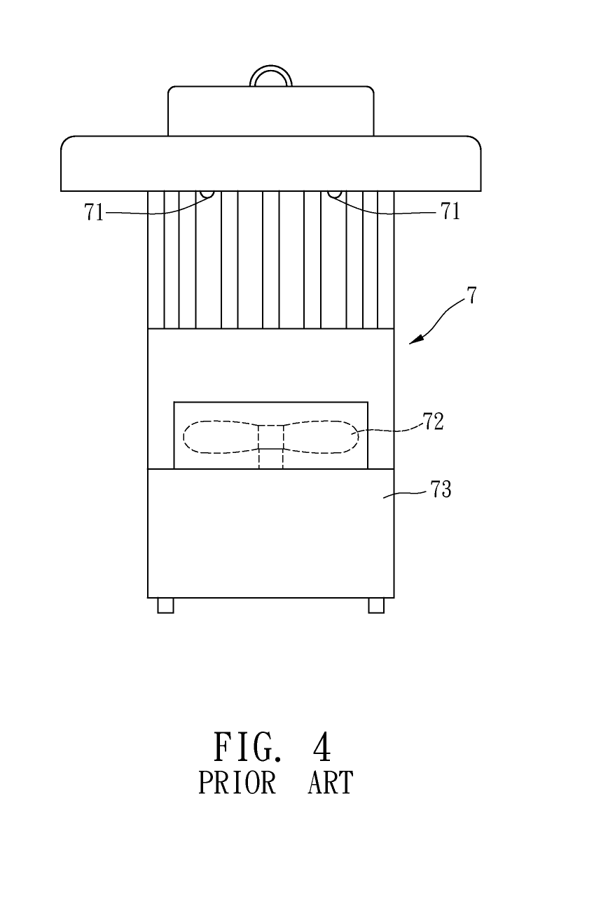

### DETAILED DESCRIPTION OF THE PREFERRED EMBODIMENTS

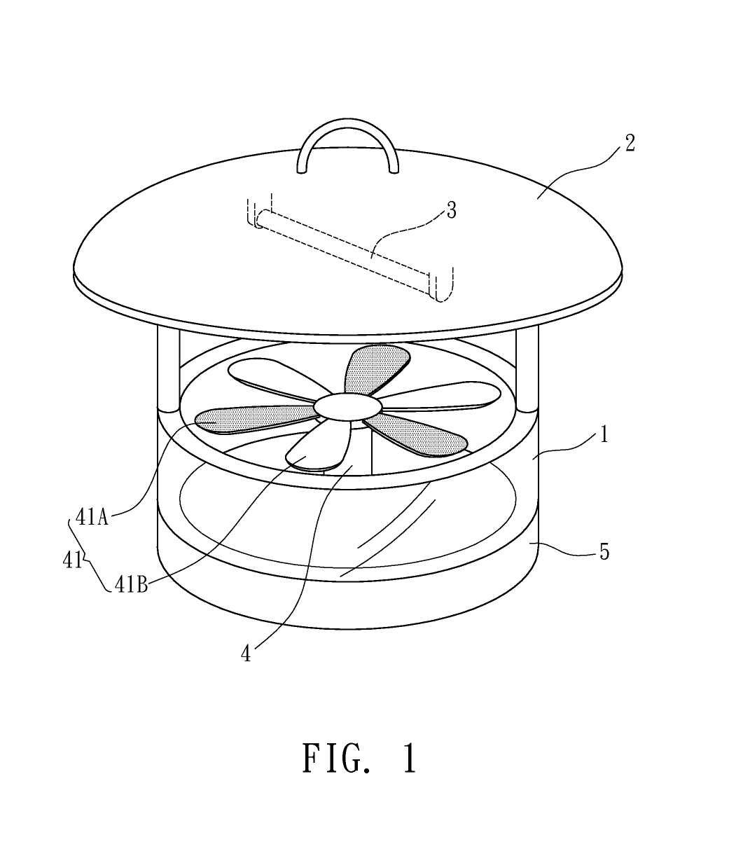

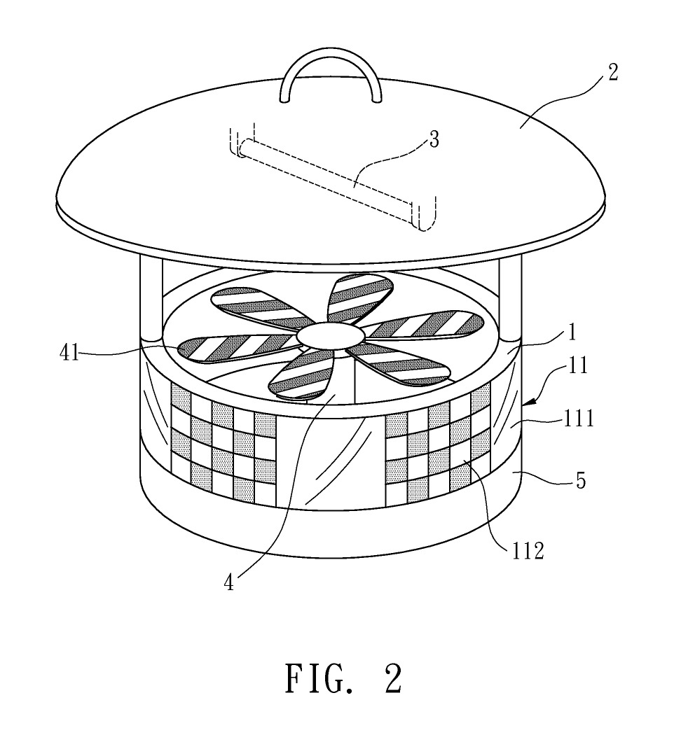

With reference to FIG. 1 for a perspective view of a first embodiment of a mosquito trap in accordance with the present invention. The mosquito trap comprises a case 1 being transparent, a light cover 2 mounted on a top end of the case 1, and an inducing light 3 located in the light cover 2. In this embodiment, the inducing light 3 and emit a light with a wave length ranging from 370 nm to 380 nm to induce mosquitoes to get close the mosquito trap. A fan 4 is mounted in the bottom of the case 1. The fan 4 is capable of producing airflow toward the inside of the case 1 when starting to rotate, thereby the mosquitoes can be entrained into the case 1, falling down to a collecting box 5 located beneath the case 1 and then air-dried to die. In one aspect, the fan 4 has multiple black and white fan blades 41 to produce twinkling as the fan starts to rotate. In detail, there are two examples of the fan blades 41. As shown in FIG. 1, some of the blades 41 are black fan blades 41A, and others are white fan blades 41B. Each of the black fan blades 41A and each of the white fan blades 41B are alternately arranged to form the fan 4. Instead, as shown in FIG. 2, each of the fan blades 41 has black and white strips alternately arranged thereon.

When the fan 4 formed according to the two examples described above rotates, the fan blades 41 rotates with the fan 4 to let the black portion and the white portion of the fan blades 41 move quickly to form twinkling. The twinkling formed by the fan blades 41 can be more obvious via the illumination of the inducing light 3, such that the effect of trapping mosquitoes is improved.

With reference to FIG. 2 for a perspective view of a second embodiment of a mosquito trap in accordance with the present invention. The embodiment shown in FIG. 2 is based on the first embodiment shown in FIG. 1. In one aspect, the case 1 has a color band 11 mounted around the outside thereof near the fan 4. The color band 11 is formed by multiple colorless part 111 being transparent and multiple colorful part 112 having alternate black and white grid pattern. Similarly, in this embodiment, the black and white fan blades 41 are moved quickly to form twinkling, and the twinkling is displayed on the colorless part 111. The effect of twinkling is reinforced with the alternate black and white strips on color band 11 of the case 1, such that the effect of trapping mosquitoes is also improved.

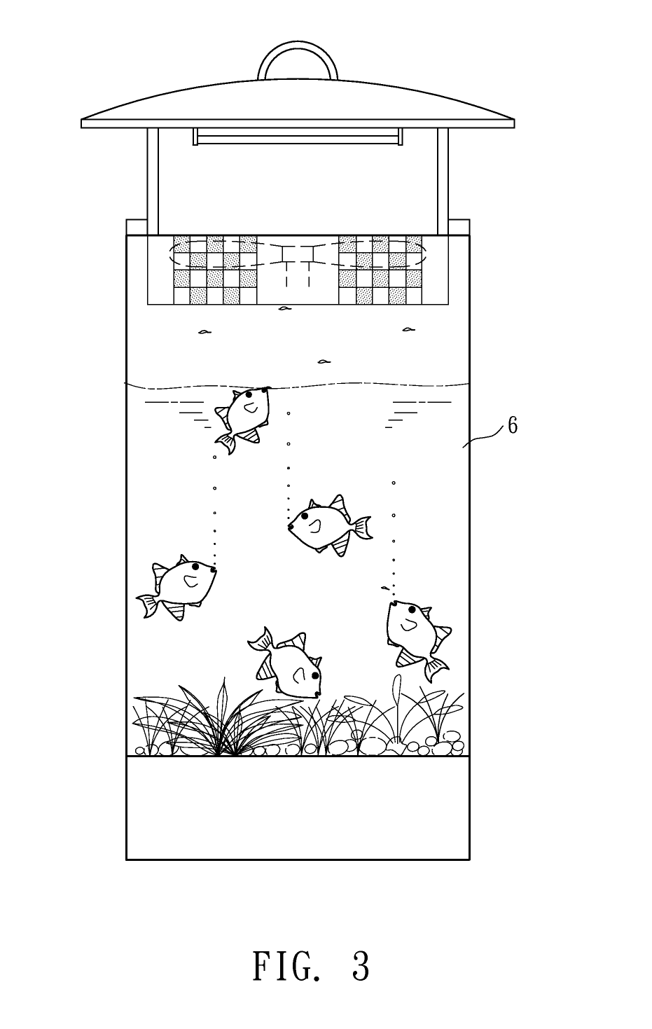

Furthermore, as shown in FIG. 3 for a third embodiment of a mosquito trap in accordance with the present invention. The collecting box 5 located at the bottom of the mosquito trap and used for collecting bodies of trapped mosquitoes is removed. Then, the mosquito trap is put on an aquarium 6 capable of cultivating fish to let the bodies of trapped mosquitoes falling down to the aquarium 6. The principle of the mosquito trap in this embodiment is the same as that of other embodiments described above, but the mosquito trap in this embodiment has some advantages. First, the mosquitoes caught by the mosquito trap fall down to the aquarium 6 to feed fish, so that users need not to deal with those bodies of the trapped mosquitoes and not worry about that the bodies of mosquitoes become pollutants. In addition, the cost of the feed for fish can be saved. Second, after being trapped, the mosquitoes fall down to the aquarium 6 and eaten by the fish, and thus there is no specific smell of hormone from the bodies of trapped mosquitoes emitted to make other mosquitoes get farther from the mosquito trap. As such, the ability of the mosquito trap can be maintained. Third, the aquarium 6 cultivating fish produce carbon dioxide which is the favor smell of mosquitoes. Therefore, the mosquito trap set on the aquarium 6 can induce mosquitoes more, thereby improving the effect of trapping mosquitoes.

What is claimed is:

1. A mosquito trap which comprises a case being transparent, a light cover mounted on a top end of the case, an inducing light located in the light cover, a fan capable of producing airflow toward the inside of the case mounted in the bottom of the case, and a collecting box located beneath the case, characterized by:
multiple fan blades having black portions and white portions and mounted in the fan, thereby producing twinkling as the fan starts to rotate.

2. The mosquito trap as claimed in claim 1, characterized in that the fan has multiple black fan blades and multiple white fan blades alternately arranged thereon.

3. The mosquito trap as claimed in claim 1, characterized in that each of the fan blades of the fan has alternate black strips and white strips.

4. The mosquito trap as claimed in claim 2 or 3, characterized in that the case further has a color band mounted around the outside thereof, and the color band has multiple colorless parts and multiple colorful parts arranged alternately, and the colorful parts has alternate black and white grid pattern.

5. A mosquito trap which comprises a case being transparent, a light cover mounted on a top end of the case, an inducing light located in the light cover, a fan capable of producing airflow toward the inside of the case mounted in the bottom of the case, and a collecting box located beneath the case, characterized by:
multiple fan blades having black portions and white portions and mounted in the fan, thereby producing twinkling as the fan starts to rotate; and
an aquarium connected to and located at the bottom of the case to let trapped mosquitoes fall down therein.

6. The mosquito trap as claimed in claim 5, characterized in that the fan has the fan has multiple black fan blades and multiple white fan blades alternately arranged thereon.

7. The mosquito trap as claimed in claim 5, characterized in that each of the fan blades of the fan has alternate black strips and white strips.

8. The mosquito trap as claimed in claim 6 or 7, characterized in that the case further has a color band mounted around the outside thereof, and the color band has multiple colorless parts and multiple colorful parts arranged alternately, and the colorful parts has alternate black and white grid pattern.
